(19) United States
(12) Patent Application Publication
(10) Pub. No.: US 2021/0179453 A1
(43) Pub. Date: Jun. 17, 2021

(54) SYSTEM AND METHOD FOR SEAWATER DESALINATION BASED ON SOLAR ENERGY

(71) Applicant: Xi'an Jiaotong University, Xi'an (CN)

(72) Inventors: Zhiguo Qu, Xi'an (CN); Qian Liu, Xi'an (CN); Di Tian, Xi'an (CN)

(21) Appl. No.: 17/005,435

(22) Filed: Aug. 28, 2020

(30) Foreign Application Priority Data
Dec. 11, 2019 (CN) 201911272330.5

(51) Int. Cl. C02F 1/46; C02F 1/461; B01D 61/46; B01D 69/02

(52) U.S. Cl. CPC C02F 1/4604; C02F 1/46104; C02F 2103/08; B01D 69/02; B01D 61/46

(57) ABSTRACT

A system and method for seawater desalination based on solar energy. In the system, the second reaction tank is connected with the first reaction tank via a cation-selective nano-film and includes the same volume and concentration of seawater as the first reaction tank. The pump is connected the second reaction tank with the third reaction tank to pump the seawater solution after the removal of cationic salts from the second tank into the third tank. The fourth reaction tank is connected to the third reaction tank via a anion-selective nano-film. The third and fourth reaction tanks are connected through a second external channel and include the same volume and concentration of seawater, and the second external channel is provided with a third valve to control the flow of liquid. The fourth reaction tank is provided with a liquid output channel.

### CROSS REFERENCE TO RELATED APPLICATION

This application claims the priority of Chinese Patent Application No. 201911272330.5, entitled “System and method for seawater desalination based on solar energy” filed with the China National Intellectual Property Administration on Dec. 11, 2019, which is incorporated herein by reference in its entirety.

### TECHNICAL FIELD

The invention relates to the technical field of seawater desalination, and in particular to a system and method for seawater desalination based on solar energy.

### BACKGROUND ART

The shortage of freshwater resources seriously influences the sustainable development and the robust growth of social economy. One of the most effective ways to solve this issue is seawater desalination, i.e. a process of removing salt from seawater to obtain freshwater. The method for seawater desalination mainly includes distillation (multi-stage flashing, multi-effect evaporation and vapor compression) membrane (reverse osmosis and electrodialysis), crystallization (freezing and hydrate method), solvent extraction, ion exchange and the like. At present, the distillation and reverse osmosis are most widely applied. However, salt deposit left in distillation process can seriously influence the efficiency of equipment and reduce its lifetime. Nowadays, reverse osmosis accounts for 50% of energy production for seawater desalination in the world, but it is still limited by high cost for low freshwater recovery and high energy consumption. To a certain extent, these methods will cause the consumption of non-renewable energy, exacerbate energy problems and cause pollution. Therefore, it is very important to look for a method for seawater desalination with efficient and energy-saving.

The use of solar energy as an energy source for seawater desalination has the characteristics of no pollution, zero emission, renewability and the like, and thus becomes an important direction for solving the dual crisis of energy and environment. At present, the application of solar energy for seawater desalination mainly includes two modes. One is that the solar energy is used for driving the surface of seawater to evaporate it into steam to obtain freshwater after condensation, which cannot be applied on a large scale due to a low utilization efficiency originated from low photo-thermal conversion efficiency and large heat loss. The other is to use the electricity generated by the photovoltaic effect to drive the dialysis process to generate freshwater, or to electrically heat seawater for desalination. Due to the relatively high cost of solar power generation at present, it is not economical to generate fresh water by using solar power to drive the dialysis process. Therefore, it has become an inevitable trend to find efficient, low-energy, reliable and sustainable methods for seawater desalination based on solar energy.

The above information disclosed in the background section is only for enhancing the understanding of invention background, and therefore it may contain information that does not form the prior art that is well known to those of ordinary skill in the art.

### SUMMARY OF THE INVENTION

In view of the above problems, an object of the present invention is to provide a system and method for seawater desalination based on solar energy to overcome the above disadvantages of the prior art. The invention object has been achieved by the following technical scheme.

A system for seawater desalination based on solar energy, comprising:

a first reaction tank, arranged with a first electrode immersed in seawater;

a second reaction tank, connected to the first reaction tank via a cation-selective nano-film and arranged with a second electrode immersed in seawater, wherein the first reaction tank and the second reaction tank are connected through an external channel and include the same volume and concentration of seawater, and the external channel is provided with a first valve to control the flow of liquid, and wherein the first electrode and the second electrode are connected through a first external circuit;

a pump, connecting the second reaction tank and a third reaction tank to pump the seawater solution after the removal of cationic salts from the second reaction tank into the third reaction tank;

a third reaction tank, arranged with a third electrode immersed in the seawater solution;

a fourth reaction tank, connected to the third reaction tank via a anion-selective nano-film and arranged with a fourth electrode immersed in the seawater, wherein the third reaction tank and the fourth reaction tank are connected through a second external channel and include the same volume and concentration of seawater, and the second external channel is provided with a third valve to control the flow of liquid, wherein the third electrode and the fourth electrode are connected through a second external circuit, and wherein the fourth reaction tank is provided with a liquid output channel.

In the system for seawater desalination based on solar energy, the cation-selective nano-film and the anion-selective nano-film comprise parallel pore ion channels from the second reaction tank to the first reaction tank, and from the fourth reaction tank to the third reaction tank, respectively.

In the system for seawater desalination based on solar energy, the cation-selective nano-film and/or anion-selective nano-film is single- or multi-layer porous semiconductor membranes with an average pore size of 2-30 nm, a thickness of each layer of not more than 100 nm, and a total thickness of not more than 500 nm.

In the system for seawater desalination based on solar energy, the parallel pore ion channels of the cation-selective nano-film comprise negatively charged surface layers.

In the system for seawater desalination based on solar energy, the parallel pore ion channels of the anion-selective nano-film comprise positively charged surface layers.

In the system for seawater desalination based on solar energy, the first reaction tank, the second reaction tank, the third reaction tank and/or the fourth reaction tank are made of quartz glass.

In the system for seawater desalination based on solar energy, the cation-selective nano-film are respectively connected to the first reaction tank and second reaction tanks via flanges, and the anion-selective nano-film are respectively connected to the third and fourth reaction tanks via flanges.

In the system for seawater desalination based on solar energy, the pump is provided with a second valve, and the liquid output channel is provided with a fourth valve; the first external circuit is provided with a first electric signal collector for controlling system to start or stop, and/or the second external circuit is provided with a second electric signal collector for controlling system to start or stop.

According to another aspect of the present invention, a method for desalination by means of the system for seawater desalination based on solar energy comprises the following steps:

the first step, sunlight irradiates the cation-selective nano-film through the second reaction tank, and the surface of the film absorbs solar energy to excite carriers;

the second step, the difference in electrochemical potential energy is generated to enable the cations of the seawater in the second reaction tank to enter the first reaction tank through the ion channel of cation-selective nano-film;

the third step, the diffusion potential is generated on the two sides of the cation-selective nano-film until the current is stable, and the first electric signal collector collects signals to control the system to shield light signals, wherein the cation concentration of liquid in the second reaction tank is lower than that in the first reaction tank;

the fourth step, the second valve and the pump is opened to discharge the seawater solution in the second reaction tank to the third reaction tank; and

the fifth step, the second valve and the pump is closed, the first valve is opened to introduce liquid in the first reaction tank into the second reaction tank and then is closed when the volume of liquid in the first reaction tank is equal to that in the second reaction tank, and then returning to the first step for cyclic desalination.

According to still another aspect of the present invention, a method for desalination by means of the system for seawater desalination, based on solar energy includes the following steps:

the first step, the third valve is opened to introduce liquid in the third reaction tank into the fourth reaction tank and then is closed when the volume of liquid in the third reaction tank is equal to that in the fourth reaction tank;

the second step, sunlight irradiates the anion-selective nano-film through the third reaction tank, and the surface of the film absorbs solar energy to excites carriers;

the third step, the difference in electrochemical potential energy is generated to enable the cation of seawater in the fourth reaction tank to enter the third reaction tank through the anion-selective nano-film ion channel;

the fourth step, the diffusion potential is generated on the two sides of anion-selective nano-film until the current is stable, and the second electric signal collector collects signals to control system to shield light signals, wherein the anion concentration of liquid in the fourth reaction tank is lower than that in the third reaction tank;

the fifth step, the fourth valve is opened to discharge the liquid in the fourth reaction tank; and

the sixth step, the fourth valve is closed to introduce the liquid in the third reaction tank into the fourth reaction tank, the third valve is closed when the volume of liquid in the fourth reaction tank is equal to that in the third reaction tank, and then returning to the first step for circular desalination.

Compared with the prior art, the invention has the beneficial effects that:

The invention does not need to provide additional relatively more electrical energy, thermal energy and salt differential energy. So that it not only avoids the complicated multi-level energy conversion in the solar energy utilization process and the energy loss in the energy conversion process at various levels, but also effectively prevents pollutants generation in seawater desalination process, and achieves the purposes of energy conservation and emission reduction. The whole desalination system only uses solar energy without other external energy consumption to realize seawater desalination and even power generation through ions osmotic transmission. According to the invention, the seawater desalination can be carried out comprehensively and directionally by removing cations and anions in seawater step by step. The whole seawater desalination system has a simple structure, convenient operation, extremely low cost and huge profit.

The above description is only an overview of the technical solutions of the present invention. In order to make the technical means of the present invention more clearly apparent, to make the implementation of the content of the description possible for those skilled in the art, and to make the above and other objects, features and advantages of the present invention more obvious, the following description is given by way of example of specific embodiments of the present invention.

### BRIEF DESCRIPTION OF THE DRAWINGS

Various other advantages and benefits of the present invention will become apparent to those of ordinary skill in the art upon reading the following detailed description of the preferred embodiments. The drawings are only for the purposes of illustrating the preferred embodiments and should not be construed as limiting the invention. It is obvious that the drawings described below are only some embodiments of the invention, and that for a person skilled in the art, other drawings can be derived from them without inventive effort. Furthermore, the same parts are designated by the same reference numerals throughout the drawings.

In the drawings:

FIG. 1 is a schematic drawing of seawater desalination system based on solar energy according to an embodiment of the present invention, wherein, the various reference numerals have the following meanings: 1-first electric signal collector; 2-first valve; 3-first reaction tank; 4-first electrode; 5-cation-selective nano-film; 6-second electrode; 7-second reaction tank; 8-second valve; 9-third reaction tank; 10-third valve; 11-liquid collection tank, 12-fourth valve; 13-fourth reaction tank; 14-fourth electrode; 15-anion-selective nano-film; 16-third electrode; 17-second electric signal collector; 22-pump.

FIG. 2 is a drawing of ion transfer in cation-selective nano-film under solar illumination of a seawater desalination system based on solar energy according to an embodiment of the present invention, wherein, the various reference numerals have the following meanings: 3-first reaction tank; 4-first electrode; 6-second electrode; 7-second reaction tank; 8-cation-selective nanochannel; 19-cation.

FIG. 3 is a drawing of ion transfer in anion-selective nano-film under solar illumination of a seawater desalination system based on solar energy according to an embodiment of the present invention, wherein, the various reference numerals have the following meanings: 9-third reaction tank; 13-fourth reaction tank; 14-fourth electrode; 16-third electrode; 20-anion-selective nanochannel; 21-anion.

FIG. 4 is a schematic drawing of the steps in the method for removing cationic salts in the system for seawater desalination based on solar energy according to an embodiment of the present invention.

FIG. 5 is a schematic drawing of the steps in the method for removing anionic salts in the system for seawater desalination based on solar energy according to an embodiment of the present invention;

FIG. 6 is a schematic drawing of the control steps of an electric signal collector in the system for seawater desalination based on solar energy according to an embodiment of the present invention.

The invention is further explained below with reference to the figures and examples.

### DETAILED DESCRIPTION OF THE EMBODIMENTS

Specific embodiments of the present invention will be described in detail below with reference to drawings. While specific embodiments of the invention are shown in the drawings, it should be understood that the invention may be embodied in various forms and should not be construed as limited to the embodiments set forth herein. Instead, these embodiments are provided so that this disclosure will be thorough and complete, and will fully convey the scope of the invention to those skilled in the art.

It should be noted that in the context of the present description and claims, certain terms are used to refer to particular components. As one skilled in the art will appreciate, various names may be used to refer to the same component. The description and claims do not intend to distinguish between components that differ in name but not function. In the following description and claims, the terms “include” and “comprise” are used in an open-ended fashion, and thus should be interpreted to mean “include, but not limited to”. The following description is a preferred embodiment of the invention, and is made for the purpose of illustrating the general principles of the invention but not for the purpose of limiting the scope of the invention. The scope of the present invention is defined by the appended claims.

For the purpose of facilitating understanding of embodiments of the present invention, the following description will be made by taking specific embodiments as examples with reference to the accompanying drawings, and the drawing are not to be construed as limiting the embodiments of the present invention.

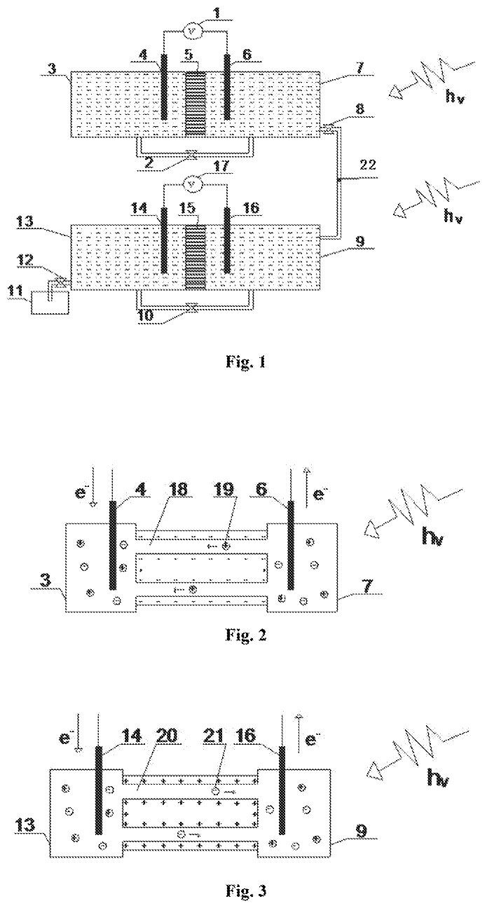

For a better understanding, as shown in FIG. 1, a system for seawater desalination based on solar energy comprises:

a first reaction tank 3, arranged with a first electrode 4 immersed in seawater;

a second reaction tank 7, connected to the first reaction tank 3 via a cation-selective nano-film 5 and arranged with a second electrode 6 immersed in seawater, wherein the first reaction tank 3 and the second reaction tank 7 are connected through an external channel and include the same volume and concentration of seawater, and the external channel is provided with a first valve 2 to control the flow of liquid, and wherein the first, electrode 4 and the second electrode 6 are connected through a first external circuit;

a pump 22, connecting the second reaction tank 7 and a third reaction tank 9 to pump the seawater solution from the second reaction tank 7 after the removal of cationic salts into a third reaction tank 9;

a third reaction tank 9, arranged with a third electrode 16 immersed in solution; and

a fourth reaction tank 13, connected to the third reaction tank 9 via a anion-selective nano-film 15 and arranged with a fourth electrode 14 immersed in the seawater, wherein the third reaction tank 9 and the fourth reaction tank 13 are connected through a second external channel and include the same volume and concentration of seawater, and the second external channel is provided with a third valve 10 to control the flow of liquid, wherein the third electrode 16 and the fourth electrode 14 are connected through a second external circuit, and wherein the fourth reaction tank 13 is provided with a liquid output channel.

In an preferred embodiment of the system for seawater desalination based on solar energy, the liquid output channel is connected to a liquid collection tank 11 via a fourth valve.

In an preferred embodiment of the system for seawater desalination based on solar energy, the cation-selective nano-film 5 and the anion-selective nano-film 15 comprise parallel pore ion channels from the second reaction tank 7 to the first reaction tank 3 and from the fourth reaction tank 13 to the third reaction tank 9, respectively.

In an preferred embodiment of the system for seawater desalination based on solar energy, cation-selective nano-film 5 and/or anion-selective nano-film 15 is single- or multi-layer porous semiconductor membranes with an average pore size of 2-30 nm, a thickness of each layer of not more than 100 nm, and a total thickness of not more than 500 nm.

In an preferred embodiment of the system for seawater desalination based on solar energy, the parallel pore ion channels of the cation-selective nano-film 5 comprise negatively charged surface layers.

In an preferred embodiment of the system for seawater desalination based on solar energy, the parallel pore ion channels of the anion-selective nano-film 15 comprise positively charged surface layers.

In an preferred embodiment of the system for seawater desalination based on solar energy, the first reaction tank 3, the second reaction tank 7, the third reaction tank 9 and/or the fourth reaction tank 13 are made of quartz glass.

In an preferred embodiment of the system for seawater desalination based on solar energy, the cation-selective nano-film 5 are respectively connected to the first reaction tank 3 and the second reaction tank 7 via flanges, and the anion-selective nano-film 15 are respectively connected to the third reaction tank 9 and the fourth reaction tank 13 via flanges to prevent the liquid from leaking at the joint.

In an preferred embodiment of the system for seawater desalination based on solar energy, pump 22 is provided with a second valve 8, and the liquid output channel is provided with a fourth valve 12; the first external circuit is provided with a first electric signal collector 1 for controlling system to start or stop, and/or the second external circuit is provided with a second electric signal collector 17 for controlling system to start or stop.

According to an embodiment of the invention, the principle of ion migration in the cation-selective nano-film 5 under the sunlight in the system for seawater two-step desalination based on solar energy is shown in FIG. 2. A negatively charged surface layer is formed by the parallel pore channels on the semiconductor film. When the aperture is reduced to a certain degree, namely 2-30 nm, the electrical double layers on upper surface and lower surface are superposed. According to electrostatic theory, only ions with opposite charges, namely cations, can pass through the channel. Under sunlight, the surface of membrane is excited to generate carriers, which has difference in migration rate, leading to form an electrochemical potential difference on the membrane, thereby migrating cation 19 in the second reaction tank 7 to the first reaction tank 3 through the cation-selective nano-channel 18.

According to an embodiment of the invention, the principle of ion migration in the anion-selective nano-film 15 under the sunlight in the system for seawater two-step desalination based on solar energy is shown in FIG. 3. A positively charged surface layer is formed by the parallel pore channels on the semiconductor film. When the aperture is reduced to a certain degree, namely 2-30 nm, the electrical double layers on upper surface and lower surface are superposed. According to electrostatic theory, only ions with opposite charges, namely anions, can pass through the channel. Under sunlight, the surface of the membrane is excited to generate carriers, which has difference in migration rate, leading to form an electrochemical potential difference on the membrane, thereby migrating anion 21 in the fourth reaction tank 13 to the third reaction tank 9 through the anion-selective nano-channel 20.

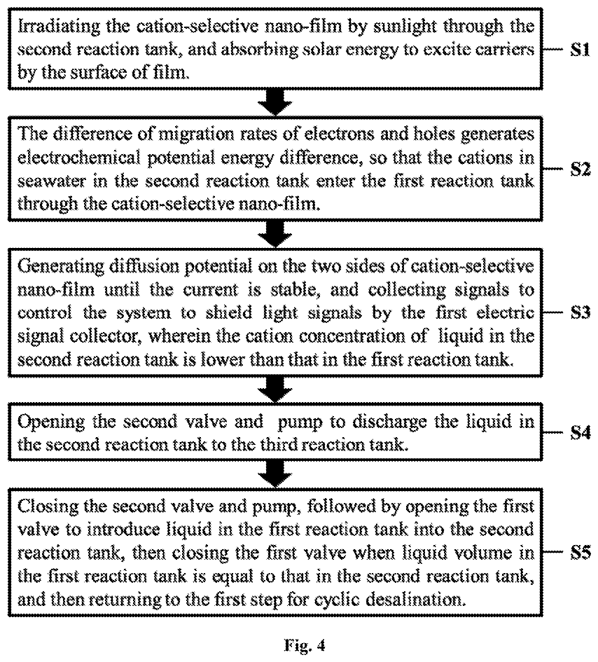

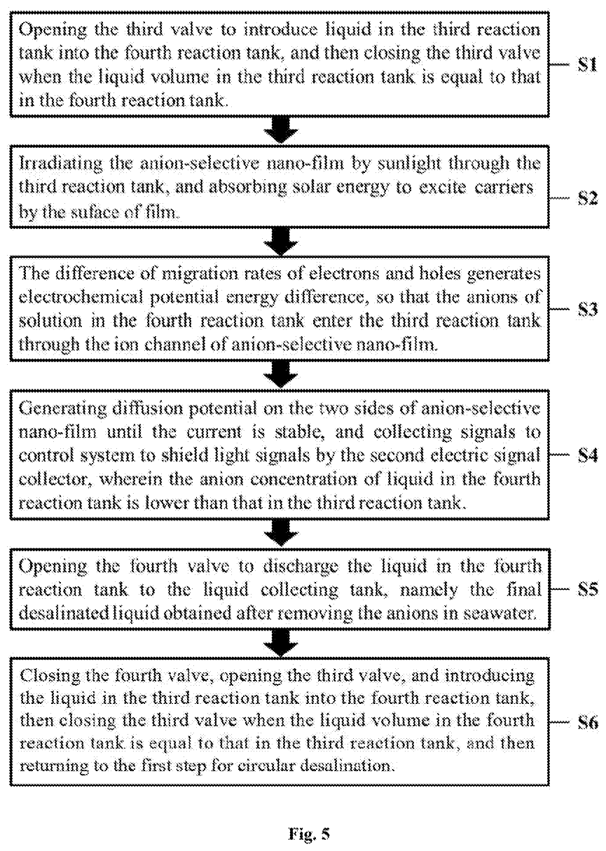

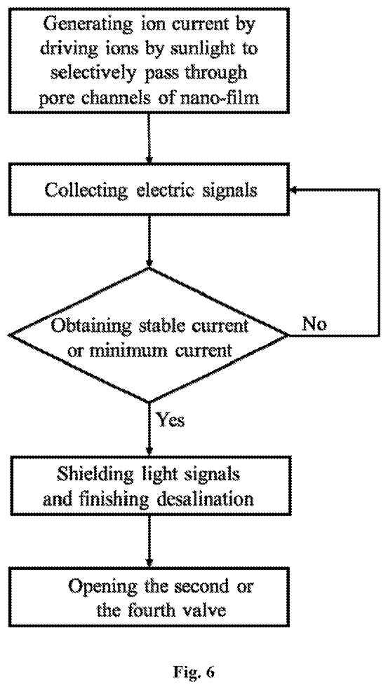

As shown in FIG. 4, a method for desalination by means of the system for seawater desalination based on solar energy comprises the following steps:

the first step, sunlight irradiates the cation-selective nano-film 5 through the second reaction tank 7, and the surface of the film absorbs solar energy to excite carriers;

the second step, the difference in electrochemical potential energy is generated to enable the cations of seawater in the second reaction tank 7 to enter the first reaction tank 3 through the ion channel of the cation-selective nano-film 5;

the third step, a diffusion potential is generated on the two sides of the cation-selective nano-film 5 until the current is stable, and the first electric signal collector 1 collects signals to control the system to shield light signals, wherein the concentration of cationic salts in the second reaction tank 7 is lower than that in the first reaction tank 3;

the fourth step, the second valve 8 and the pump is opened to discharge the seawater solution in the second reaction tank 7 to the third reaction tank 9;

the fifth step, the second valve 8 and the pump is closed the first valve 2 is opened to introduce the liquid in the first reaction tank 3 into the second reaction tank 7 and then is closed when the volume of liquid in the first reaction tank 3 is equal to that in the second reaction tank 7, and then returning to the first step for cyclic desalination.

In an embodiment, the method for removing cationic salts by the system for seawater desalination based on solar energy is as follows:

The first external circuit is connected to access the collected sunlight. The sunlight irradiates the cation-selective nano-film 5 connected with the first reaction tank 3 through the second reaction tank 7, and the nano-film surface absorbs solar energy to excite carriers. Due to the photo-Dember effect, the difference of migration rates of electrons and holes in the cation-selective nano-film destroys the surface symmetry and generates electrochemical potential difference, so that the cations in seawater in the second reaction tank 7 enter the first reaction tank 3 through the selective channel of the nano-film. A diffusion potential is generated due to ion migration in the nanopore channel. In order to maintain the electro-neutrality of the solution within the reaction tank, electrons migrate from the second electrode 6 to the first electrode 4 through the external circuit. Until the current is stable or reaches the minimum value, the first electric signal collector 1 collects signals to control system to shield light signals. The removal of the cationic salts is finished. At this point, the concentration of cationic salts in the second reaction tank 7 is lower than that in the first reaction tank 3. Subsequently, the second valve 8 is opened to discharge the liquid in the second reaction tank 7 to the third reaction tank 9 and then is closed. First valve 2 is opened to introduce the liquid in the first reaction tank 3 into the second reaction tank 7 and then is closed when the volume of liquid in the two reaction tanks are equal. After that, the first desalting step is repeated.

As shown in FIG. 5, a method for desalination by means of the system for seawater desalination based on solar energy comprises the following steps:

the first step, the third valve 10 is opened to lead liquid in the third reaction tank 9 into the fourth reaction tank 13, and then is closed when the volume of liquid in the third reaction tank 9 is equal to that in the fourth reaction tank 13;

the second step, sunlight irradiates the anion-selective nano-film 15 through the third reaction tank 9, and the surface of the film absorbs solar energy to excite carriers;

the third step, the difference in electrochemical potential energy is generated to enable the cation of seawater in the fourth reaction tank 13 to enter the third reaction tank 9 through the ion channel of the anion-selective nano-film 15;

the fourth step, a diffusion potential is generated on the two sides of the anion-selective nano-film 15 until the current is stable, and the second electric signal collector 17 collects signals to control the system to shield light signals, wherein the concentration of the anionic salts in the liquid in the fourth reaction tank 13 is lower than that in the third reaction tank 9;

the fifth step, the fourth valve 12 is opened to discharge the liquid in the fourth reaction tank 13; and

the sixth step, the fourth valve 12 is closed, the third valve 10 is opened to introduce liquid in the third reaction tank 9 into the fourth reaction tank 13 and then is closed when the volume of liquid in fourth reaction tank 13 is equal to that in the third reaction tank 9, and then returning to the first step for cyclic desalination.

In an embodiment, the method for removing anionic salts by the system for seawater desalination based on solar energy comprises the following steps:

The third valve 10 is opened to introduce liquid in the third reaction tank 9 into the fourth reaction tank 13 and then is closed when the volume of liquid in the two reaction tanks are equal. Then, the external circuit is connected to access the collected sunlight. The sunlight irradiates the anion-selective nano-film 15 connected with the fourth reaction tan k 13 through the third reaction tank 9, and the nano-film surface absorbs solar energy to excite carriers. Due to the photo-Member effect, the difference of migration rates of electrons and holes in the anion-selective nano-film destroys the surface symmetry and generates electrochemical potential difference, so that the anions in solution in the fourth reaction tank 13 enter the third reaction tank 9 through the selective channel of the nano-film. A diffusion potential is generated due to ion migration in the nanopore channel. In order to maintain the electro-neutrality of the solution within the reaction tank, electrons migrate from the third electrode 16 to the fourth electrode 14 through the outer channel. Until the current is stable or reaches the minimum value, the second electric signal collector 17 collects signals to control system to shield light signals. The removal of the anionic salts is finished. At this point, the concentration of anion salt in the fourth reaction tank 13 is lower than that in the third reaction tank 9. Subsequently, the fourth valve 12 is opened to discharge and collect the liquid in the fourth reaction tank 13 to the liquid collecting tank 11, namely the final desalinated liquid obtained after removing the anions in the seawater. The fourth valve 12 is closed, and the third valve 10 is opened to introduce liquid in the third reaction tank 9 into the fourth reaction tank 13 and then is closed when the volume of liquid in two reaction tanks are equal. After that, the second step for desalination is repeated.

In an embodiment, a method for desalination by means of the system for seawater desalination based on solar energy comprises the following steps:

the first step, sunlight irradiates the cation-selective nano-film 5 through the second reaction tank 7, and the surface of the film absorbs solar energy to excite carriers;

the second step, the difference in electrochemical potential energy is generated to enable the cation of seawater in the second reaction tank 7 to enter the first reaction tank 3 through the ion channel of the cation-selective nano-film 5;

the third step, the diffusion potential is generated on the two sides of the cation-selective nano-film 5 until the current is stable, and the first electric signal collector 1 collects signals to control the system to shield light signals, wherein the concentration of anionic salts in the second reaction tank 7 is lower than that in the first reaction tank 3;

the fourth step, the second valve 8 and the pump are opened to discharge the seawater solution in the second reaction tank 7 to the third reaction tank 9;

the fifth step, the second valve 8 and the pump are closed, the first valve 2 is opened to introduce liquid in the first reaction tank 3 into the second reaction tank 7 and then is closed when the volume of liquid in first reaction tank 3 is equal to that in second reaction tank 7, and then returning to the first step for cyclic desalination;

the sixth step, the second valve 8 and the pump 22 are opened to introduce liquid in the second reaction tank 7 into the third reaction tank 9, and then are closed; and

the seventh step, the third valve 10 is opened to lead liquid in the third reaction tank 9 into the fourth reaction tank 13 and then is closed when the volume of liquid in the third reaction tank 9 is equal to that in the fourth reaction tank 13;

the eighth step, sunlight irradiates the anion-selective nano-film 15 through the third reaction tank 9, and the surface of film absorbs solar energy to excite carriers;

the ninth step, the difference in electrochemical potential energy is generated to enable the cation of the seawater in fourth reaction tank 13 to enter the third reaction tank 9 through the ion channel of the anion-selective nano-film 15;

the tenth step, the diffusion potential is generated on the two sides of the anion-selective nano-film 15 until the current is stable, and the second electric signal collector 17 collects signals to control the system to shield light signals, wherein the concentration of the anionic salts in the liquid in the fourth reaction tank 13 is lower than that in the third reaction tank 9;

the eleventh step, the fourth valve 12 is opened to discharge the liquid in the fourth reaction tank 13; and

the twelfth step, the fourth valve 12 is closed, the third valve 10 is opened to lead the liquid in the third reaction tank 9 into the fourth reaction tank 13 and then is closed when the volume of liquid in the fourth reaction tank 13 is equal to that in the third reaction tank 9, and then returning to the sixth step, the seventh step or the eighth step for cyclic desalination.

The invention directly utilizes solar energy to realize the desalination of salt-difference-free gradient seawater and simultaneously perform ion permeation power generation. The system of seawater two-step desalination based on solar energy has a simple structure, convenient operation, no additional electric energy consumption and pollutant generation, low energy consumption and cost, and has a great improvement in the recovery efficiency of freshwater.

### INDUSTRIAL APPLICABILITY

The system and method for seawater desalination based on solar energy can be manufactured and used in the field of seawater desalination.

The foregoing describes the general principles of the present application in conjunction with specific embodiments; however, it is noted that the advantages, effects and the like mentioned in the present application are merely examples but not limiting, and they should not be considered as essential to the various embodiments of the present application. Furthermore, the foregoing disclosure of specific details is for the purpose of illustration and description but not intended to be limiting because the foregoing disclosure is not intended to be exhaustive or to limit the disclosure to the precise details disclosed.

The foregoing description has been presented for the purposes of illustration and description. Furthermore, the description is not intended to limit embodiments of the application to the form disclosed herein. While a number of example aspects and embodiments have been discussed above, those of skill in the art will recognize certain variations, modifications, alterations, additions and sub-combinations thereof.

1. A system for seawater desalination based on solar energy, comprising:
a. a first reaction tank, arranged with a first electrode immersed in seawater;
b. a second reaction tank, connected to the first reaction tank via a cation-selective nano-film and arranged with a second electrode immersed in seawater, wherein the first reaction tank and the second reaction tank are connected through an external channel and include the same volume and concentration of seawater, and the external channel is provided with a first valve to control the flow of liquid, and wherein the first electrode and the second electrode are connected through a first external circuit;
c. a pump, connecting the second reaction tank and a third reaction tank to pump the seawater solution after the removal of cationic salts from the second reaction tank into the third reaction tank;
d. the third reaction tank, arranged with a third electrode immersed in the seawater solution; and
e. a fourth reaction tank, connected to the third reaction tank via a anion-selective nano-film and arranged with a fourth electrode immersed in the seawater, wherein the third reaction tank and the fourth reaction tank are connected through a second external channel and include the same volume and concentration of seawater, and the second external channel is provided with a third valve to control the flow of liquid, wherein the third electrode and the fourth electrode are connected through a second external circuit, and wherein the fourth reaction tank is provided with a liquid output channel.

2. The system for seawater desalination based on solar energy of claim 1, wherein the cation-selective nano-film and the anion-selective nano-film comprise parallel pore ion channels from the second reaction tank to the first reaction tank and from the fourth reaction tank to the third reaction tank, respectively.

3. The system for seawater desalination based on solar energy of claim 2, wherein the cation-selective nano-film and/or the anion-selective nano-film is single- or multi-layer porous semiconductor membranes with an average pore size of 2-30 nm, a thickness of each layer of not more than 100 nm, and a total thickness of not more than 500 nm.

4. The system for seawater desalination based on solar energy of claim 2, wherein the parallel pore ion channels of the cation-selective nano-film comprise negatively charged surface layers.

5. The system for seawater desalination based on solar energy of claim 2, wherein the parallel pore ion channels of the anion-selective nano-film comprise a positively charged surface layers.

6. The system for seawater desalination based on solar energy of claim 1, wherein the first reaction tank, the second reaction tank, the third reaction tank and/or the fourth reaction tank are made of quartz glass.

7. The system for seawater desalination based on solar energy of claim 1, wherein the cation-selective nano-film are respectively connected to the first reaction tank and the second reaction tanks via flanges, and the anion-selective nano-film are respectively connected to the third and fourth reaction tanks via flanges.

8. The system for seawater desalination based on solar energy of claim 1, wherein the pump is provided with a second valve, and the liquid output channel is provided with a fourth valve; the first external circuit is provided with a first electric signal collector for controlling system to start or stop, and/or the second external circuit is provided with a second electric signal collector for controlling system to start or stop.

9. A method for desalination by means of the system for seawater desalination based on solar energy as defined in claim 1, comprising the following steps:
i: irradiating the cation-selective nano-film by sunlight through the second reaction tank, and absorbing solar energy to excite carriers;
ii: generating the difference in electrochemical potential energy to enable the cations of the seawater in the second reaction tank to enter the first reaction tank through an ion channel of cation-selective nano-film;
iii: generating diffusion potential on the two sides of the cation-selective nano-film until the current is stable, and collecting signals to control the system to shield light signals by a first electric signal collector, wherein a cation concentration of the liquid in the second reaction tank is lower than that in the first reaction tank;
iv: opening a second valve and pump to discharge the seawater solution in the second reaction tank to the third reaction tank; and
v: closing the second valve and the pump, followed by opening the first valve to introduce liquid in the first reaction tank into the second reaction tank, then closing the first valve when the volume of liquid in the first reaction tank is equal to that in the second reaction tank, and then returning to the irradiating step for cyclic desalination.

10. A method for desalination by means of the system for seawater desalination based on solar energy as defined in claim 1, comprising the following steps:
i: opening the third valve to introduce liquid in the third reaction tank into the fourth reaction tank, and then closing the third valve when the volume of liquid in the third reaction tank is equal to that in the fourth reaction tank;
ii: irradiating the anion-selective nano-film by sunlight through the third reaction tank, and absorbing solar energy to excite carriers by the surface of the film;
iii: generating the difference in electrochemical potential energy based on a photo-Dember effect to enable the anion of seawater in the fourth reaction tank to enter the third reaction tank through an anion-selective nano-film ion channel;
iv: generating diffusion potential on the two sides of the anion-selective nano-film until the current is stable, and collecting signals to control system to shield light signals by a second electric signal collector, wherein an anion concentration of liquid in the fourth reaction tank is lower than that in the third reaction tank;
v: opening a fourth valve to discharge the liquid in the fourth reaction tank; and
vi: closing the fourth valve and introducing the liquid in the third reaction tank into the fourth reaction tank, then closing the third valve when the volume of liquid in the fourth reaction tank is equal to that in the third reaction tank, and then returning to the opening step for circular desalination.
